(19) United States
(12) Patent Application Publication
(10) Pub. No.: US 2022/0026227 A1
(43) Pub. Date: Jan. 27, 2022

(54) NAVIGATION ROUTE DETERMINATION METHOD, DEVICE, AND STORAGE MEDIUM

(71) Applicant: BEIJING BAIDU NETCOM SCIENCE TECHNOLOGY CO., LTD., BEIJING (CN)

(72) Inventor: Weimin LIU, Beijing (CN)

(21) Appl. No.: 17/450,260

(22) Filed: Oct. 7, 2021

(30) Foreign Application Priority Data
Mar. 25, 2021 (CN) 202110320943.2

(51) Int. Cl. G01C 21/34

(52) U.S. Cl. CPC G01C 21/3461

(57) ABSTRACT

A method for determining a navigation route, an electronic device and a storage medium are provided, which are related to the fields of intelligent transportation, electronic maps, etc. The method includes: acquiring a first candidate route within a first distance to a navigation destination from a map; determining an attribute of the first candidate route, the attribute including a navigation route and a non-navigation route; determining a target route with the attribute of the navigation route in the map based on at least one selected from a group consisting of the navigation destination and the first candidate route, in a case where the attribute of the first candidate route is the non-navigation route.

### CROSS-REFERENCE TO RELATED APPLICATIONS

This disclosure claims priority to Chinese patent application, No. 202110320943.2, entitled “Navigation Route Determination Method, Apparatus, Device, and Storage Medium”, filed with the Chinese Patent Office on Mar. 25, 2021, which is hereby incorporated by reference in its entirety.

### TECHNICAL FIELD

The present disclosure relates to the technical field of data processing, and in particular to the fields of intelligent transportation, electronic maps, etc.

### BACKGROUND

The determination of navigation routes can be corresponding to the road binding technology of map navigation. For geographic locations of a given start point and a destination point in map navigation, determining a road corresponding to the two points is called as start-destination road binding technology.

In relevant technologies, the determination of the navigation routes depends on waypoints.

### SUMMARY

The present disclosure provides a navigation route determination method, apparatus, device and storage medium.

According to an aspect of the present disclosure, a method for determining a navigation route is provided, the method specifically including the following steps:

acquiring a first candidate route within a first distance to a navigation destination from a map;

determining an attribute of the first candidate route, the attribute including a navigation route and a non-navigation route;

determining a target route with the attribute of the navigation route in the map based on at least one selected from a group consisting of the navigation destination and the first candidate route, in a case where the attribute of the first candidate route is the non-navigation route.

According to another aspect of the present disclosure, an apparatus for determining a navigation route is provided, the apparatus specifically including the following assemblies:

a first candidate route acquisition module configured for acquiring a first candidate route within a first distance to a navigation destination from a map;

a first candidate route attribute determination module configured for determining an attribute of the first candidate route, the attribute including a navigation route and a non-navigation route;

a target route determination module configured for determining a target route with the attribute of the navigation route in the map based on at least one selected from a group consisting of the navigation destination and the first candidate route, in a case where the attribute of the first candidate route is the non-navigation route.

According to another aspect of the present disclosure, an electronic device is provided, including:

at least one processor; and

a memory communicatively connected to the at least one processor, wherein

the memory stores instructions executable by the at least one processor, wherein the instructions are executed by the at least one processor to enable the at least one processor to perform the method according to any embodiment of the present disclosure.

According to another aspect of the present disclosure, a non-transitory computer readable storage medium having computer instructions stored thereon is provided, wherein the computer instructions are executed by a computer to enable the computer to perform the method according to any embodiment of the present disclosure.

According to another aspect of the present disclosure, a computer program product is provided, including a computer program, wherein the computer program, when executed by a processor, performs the method according to any embodiment of the present disclosure.

It is to be understood that the contents described in this section is not intended to identify the key or important features of the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are included to provide a better understanding of the present technical solution and are not intended to limit the present disclosure, in which:

FIG. 1 is a flow diagram showing a navigation route determination method according to an embodiment of the present disclosure;

FIG. 2 is a flow diagram showing the determination of a target route with the attribute of a navigation route according to an embodiment of the present disclosure;

FIG. 3 is a flow diagram showing the determination of a target route with the attribute of a navigation route according to an embodiment of the present disclosure;

FIG. 4 is a schematic diagram showing a map application for navigation according to an embodiment of the present disclosure;

FIG. 5 is a flow diagram showing the determination of a target route with the attribute of a navigation route according to an embodiment of the present disclosure;

FIG. 6 is a schematic diagram showing a navigation route determination apparatus according to an embodiment of the present disclosure; and

FIG. 7 is a block diagram of an electronic device used to implement the navigation route determination method according to an embodiment of the present application.

### DETAILED DESCRIPTION OF THE DRAWINGS

The following describes exemplary embodiments of the present disclosure with reference to the accompanying drawings, which include various details of the embodiments of the present disclosure to facilitate understanding and should be considered as merely exemplary. Accordingly, one of the ordinary skills in the art should appreciate that various changes and modifications can be made to the embodiments described herein without departing from the scope and spirit of the present disclosure. Also, descriptions of well-known functions and structures are omitted from the following description for clarity and conciseness.

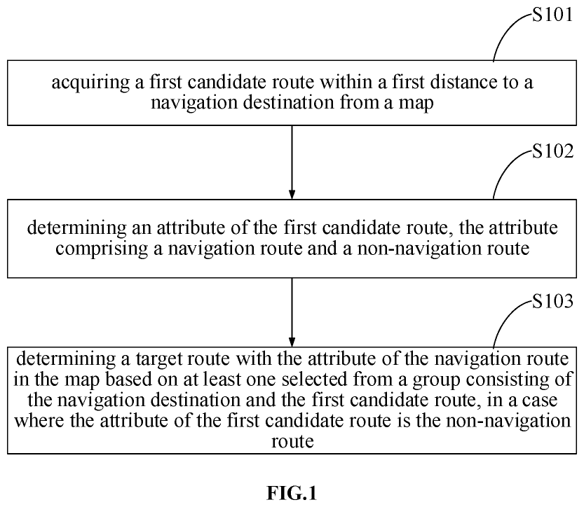

As shown in FIG. 1, the present disclosure relates to a method for determining a navigation route, wherein the method can specifically include the following steps:

S101: acquiring a first candidate route within a first distance to a navigation destination from a map;

S102: determining an attribute of the first candidate route, the attribute including a navigation route and a non-navigation route;

S103: determining a target route with the attribute of the navigation route in the map based on at least one selected from a group including of the navigation destination and the first candidate route, in a case where the attribute of the first candidate route is the non-navigation route.

The foresaid method of the present disclosure can be executed by a cloud, a server, etc. of a map application for navigation. The map application for navigation can be installed on intelligent terminals such as mobile phones, or on carriers such as central control terminals of vehicles. The carrier of the map application for navigation may act as the front end to receive instructions from users and display the navigation routes. The cloud or the server of the map application for navigation can perform the method for determining a navigation route.

The navigation destination may be in the form of characters input by a user into a search box and may also be an address selected by a user in the map.

The foresaid solution of the present disclosure can be used in a scenario where the waypoint cannot be determined from the navigation destination, or the road where the determined waypoint is located is a non-navigation route. In such cases, a first candidate route can be searched in the map based on the navigation destination. For example, the navigation destination can be set as the center of a circle, and the first distance can be set as the radius. The route(s) in the range of the first distance can be determined as the first candidate route(s).

Each candidate route can have corresponding attribute. The attribute may include a navigation route and a non-navigation route. Exemplarily, the non-navigation route may be a non-motor vehicle lane such as a sidewalk or a bicycle lane and may also be a blocked road such as a blocked highway or express way.

In a case that the attribute of the first candidate route within the first distance is the non-navigation route, it can be indicated that there is no appropriate target route in proximity to the navigation destination. In this case, searching may be performed based on at least one of the group consisting of the first candidate route(s) and the navigation destination in the map, to determine a target route with the attribute of the navigation route.

For example, according to the connectivity with the first candidate route, a route connected to the first candidate route within a predetermined distance may be taken as the target route. Otherwise, according to the distance to the navigation destination, a route with the attribute of the navigation route may also be selected to be the target route.

By the solution above, the connectivity between routes is fully considered. In a special scenario where there is no waypoint in proximity to the navigation destination and no candidate route with the attribute of the navigation route, the case that the vehicle cannot arrive and the case that a non-navigation route is wrongly determined to be the target route are eliminated, avoiding navigating a user to a wrong route. The accuracy of the determination of a navigation route can be improved efficiently.

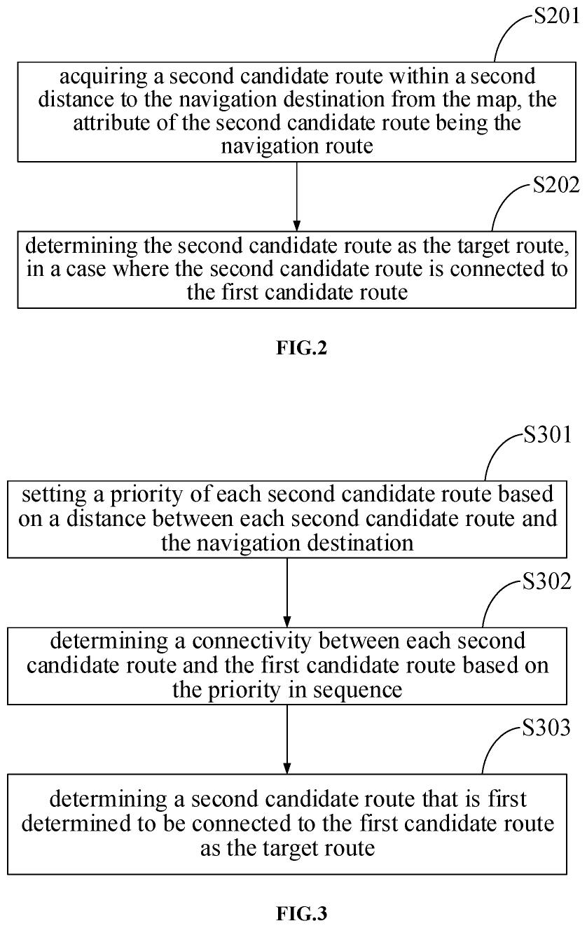

As shown in FIG. 2, in one implementation, determining the target route with the attribute of the navigation route in the map involved in step S103, can specifically include the following steps:

S201: acquiring a second candidate route within a second distance to the navigation destination from the map, the attribute of the second candidate route being the navigation route;

S202: determining the second candidate route as the target route, in a case where the second candidate route is connected to the first candidate route.

As discussed above, the non-navigation route may be a non-motor vehicle lane and may also be a blocked road. In a case that there is only non-navigation route within the first distance to the navigation destination, the search range can be expanded for continuing searching.

For example, the second candidate route(s) within the second distance to the navigation destination can be acquired from the map. The second candidate route(s) can be limited to the candidate route(s) with the attribute of the navigation route. With the navigation destination as the center of a circle and the second distance as the radius, the candidate route(s) with the attribute of the navigation route is determined to be the second candidate route(s).

Checking the connectivity between the second candidate route(s) and the first candidate route(s). In a case that a second candidate route is connected to the first candidate route, the second candidate route then can be determined to be the target route.

By the solution above, it can overcome the defect that a non-navigation route is determined to be the target route, causing the application unable to plan a correct navigation route.

As shown in FIG. 3, in one implementation, the step S103 may further include the following specific steps:

S301: setting a priority of each second candidate route based on a distance between each second candidate route and the navigation destination;

S302: determining a connectivity between each second candidate route and the first candidate route based on the priority in sequence; S303: determining a second candidate route that is first determined to be connected to the first candidate route as the target route.

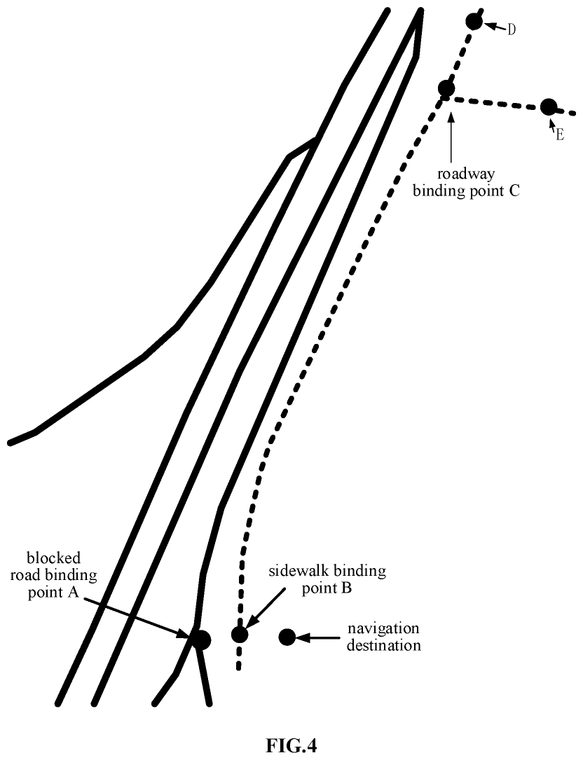

As shown in FIG. 4, the navigation destination is exemplarily marked in the figure. The point A and the point B are two waypoints nearest the navigation destination. In FIG. 4, the waypoint A is named as blocked road binding point A, and the waypoint B is named as sidewalk binding point B. The blocked road binding point A is used to demonstrate that the point A is a waypoint appearing in a blocked road, and the sidewalk binding point B is used to demonstrate that the point B is a waypoint appearing in a sidewalk.

It can thus be determined that the first candidate routes within the predetermined distance to the navigation destination are, respectively, a blocked road and a sidewalk, both the attributes of which are non-navigation routes.

Since the point B is closer to the navigation destination, the road where the point B is located can be taken as the first candidate route. In such case, a waypoint C is found within the second distance. In FIG. 4, the waypoint C is named as roadway binding point C. The roadway binding point C is used to demonstrate that the point C is a waypoint appearing in a roadway. In addition, FIG. 4 further includes a waypoint D and a waypoint E, and the attributes of the two roads where the two waypoints are located are navigation routes. The waypoint D is in the same route as the waypoint C, and the waypoint E is in the same route as the waypoint C.

Based on the above, it can be determined that the attributes of the blocked road where the point A is located and the sidewalk between the point B and the point C are non-navigation routes. Whereas, the attributes of the second candidate route between the point C and the point D and the second candidate route between the point C and the point E are navigation routes.

In such case, the distances between the navigation destination and the two second candidate routes can be calculated respectively. The distance may be a projection distance. Otherwise, the distance may be a straight-line distance between the navigation destination and the midpoint of the second candidate route.

According to the calculated distance, a priority is assigned to each second candidate route. In the scenario as shown in FIG. 4, it can be determined that the priority of the second candidate route between the point C and the point D is higher than that of the second candidate route between the point C and the point E.

Based on the priority, checking whether each second candidate route is connected to the first candidate route in turn. For example, in a case that it is first determined that the second candidate route between the point C and the point D and the first candidate route are connected, the second candidate route between the point C and the point D can be directly determined to be the target route. In this case, there is no need to determine whether the second candidate route between the point C and the point E is connected to the first candidate route.

On the contrary, in a case that the second candidate route between the point C and the point D is determined to be not connected to the first candidate route, it is necessary to continue to determine whether the second candidate route between the point C and the point E is connected to the first candidate route.

Moreover, if, within the second distance, there is no second candidate route with the attribute of the navigation route and connected to the first candidate route, the blocked road where the point A is located can be determined as the first candidate route, and the above processes can be repeated to determine whether there is a second candidate route with the attribute of the navigation route and connected to the blocked road, such as a route corresponding to the exit of the blocked road, a rout to a service station, a route to a gas station, etc.

Through the solution above, the target route nearest the navigation destination can be selected.

As shown in FIG. 5, in one implementation, the step S103 can further include the following specific steps:

S501: calculating a distance between each second candidate route and the navigation destination, in a case where the second candidate route is not connected to the first candidate route;

S502: determining the target route from the second candidate route based on the distance.

In an extreme case, a plurality of second candidate routes are not connected to the first candidate route. In this case, it can be continued to expand the search range. For example, the search range may be expanded to a third distance, so as to acquire a third candidate route within the third distance to the navigation destination from the map. The third distance is larger than the second distance.

The third candidate route(s) can be first selected by determining whether it is connected to the first candidate route, in order to determine a third candidate route that is connected to the first candidate route. The specific method is the same as that in the previous examples, and thus not described here.

In a case that each third candidate route is not connected to the first candidate route, the third candidate route can be abandoned.

The distance between each second candidate route and the navigation destination is calculated respectively, and a second candidate route with the shortest distance is selected to be the target route.

In conclusion, in the present implementation, if, within a certain distance (which may be the second distance, or the third distance) of the navigation destination, there is no second candidate route that is connected to the first candidate route, the target route can be selected from the second candidate route(s) according to the distance to the navigation destination.

Through the solution above, as the attribute of the second candidate route is the navigation route, a second candidate route with the shortest distance from the navigation destination can be selected as the target route even if the second candidate route is not connected to the first candidate route. It is ensured that the navigation route determined is practical.

In one implementation, the second distance is dynamically adjusted according to the number of the first candidate route(s).

The second distance may be inversely proportional to the number of the first candidate route(s). That is to say, the larger the number of the first candidate route(s), the smaller the second distance.

Exemplarily, the first distance may be 100 meters, and the second distance may be 500 meters. However, the second distance may be dynamically adjusted based on the number of the first candidate route(s) within 500 meters to the navigation destination. For example, in a case that there is no first candidate route within 500 meters to the navigation destination, the second distance may be adjusted to be 1,000 meters. Otherwise, in a case that the number of the first candidate route(s) within 500 meters to the navigation destination exceeds the predetermined number, the second distance may be shortened to 250 meters.

The above numerical values of the first distance and the second distance are given by way of example only, and are not limited herein.

Through the solution above, the number of the first candidate route(s) can be kept within an ideal range.

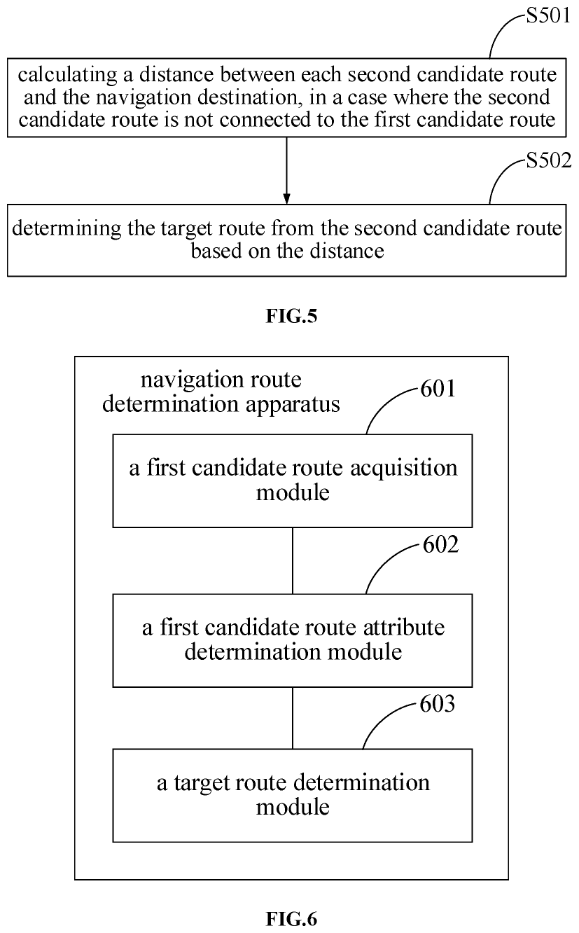

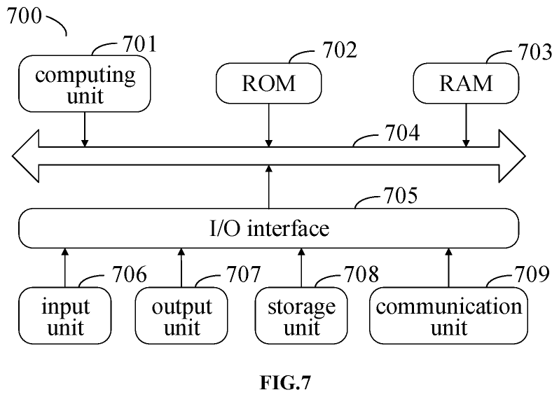

As shown in FIG. 6, the present disclosure relates to an apparatus for determining a navigation route, and the apparatus may specifically include:

a first candidate route acquisition module 601 configured for acquiring a first candidate route within a first distance to a navigation destination from a map;

a first candidate route attribute determination module 602 configured for determining an attribute of the first candidate route, the attribute including a navigation route and a non-navigation route;

a target route determination module 603 configured for determining a target route with the attribute of the navigation route in the map based on at least one selected from a group consisting of the navigation destination and the first candidate route, in a case where the attribute of the first candidate route is the non-navigation route.

In one implementation, the target route determination module 603 can specifically include:

a second navigation route acquisition sub-module configured for acquiring a second candidate route within a second distance to the navigation destination from the map, the attribute of the second candidate route being the navigation route;

a target route determination execution sub-module configured for determining the second candidate route as the target route, in a case where the second candidate route is connected to the first candidate route.

The target route determination execution sub-module can specifically include:

a priority determination unit configured for setting a priority of each second candidate route based on a distance between each second candidate route and the navigation destination;

a connectivity determination unit configured for determining a connectivity between each second candidate route and the first candidate route based on the priority in sequence;

a target route determination execution unit configured for determining a second candidate route that is first determined to be connected to the first candidate route as the target route.

In one implementation, the target route determination module 603 may further include:

a distance calculation sub-module configured for calculating a distance between each second candidate route and the navigation destination, in a case where the second candidate route is not connected to the first candidate route;

a second target route determination execution sub-module configured for determining the target route from the second candidate route based on the distance.

In one implementation, the second distance is dynamically adjusted according to the number of the first candidate route.

According to the embodiments of the present disclosure, the present disclosure also provides an electronic device, a readable storage medium, and a computer program product.

FIG. 7 is a schematic block diagram showing an electronic device 700 for implementing the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processors, cellular telephones, smart phones, wearable equipment, and other similar computing devices. The components, connections and relationships thereof, and functions thereof shown herein are by way of example only and are not intended to limit the implementations of the present disclosure described and/or claimed herein.

As shown in FIG. 7, a device 700 includes a computing unit 710 that may perform various suitable actions and processes according to a computer program stored in a read only memory (ROM) 720 or a computer program loaded from a storage unit 780 into a random access memory (RAM) 730. In the RAM 730 various programs and data required by the operation of the device 700 may also be stored. The computing unit 710, the ROM 720 and the RAM 730 are connected to each other via a bus 740. An input and output (I/O) interface 750 is also connected to the bus 740.

Multiple components in the device 700 are connected to the I/O interface 750, including: an input unit 760, such as a keyboard, a mouse, etc.; an output unit 770, such as various types of displays, speakers, etc.; a storage unit 780, such as a magnetic disk, an optical disk, etc.; and a communication unit 790, such as a network card, a modem, a wireless communication transceiver, etc. The communication unit 790 allows the electronic device 700 to exchange information/data with other devices over a computer network, such as the Internet, and/or various telecommunication networks.

The computing unit 710 may be various general purpose and/or special purpose processing assemblies having processing and computing capabilities. Some examples of the computing unit 710 include, but are not limited to, a central processing unit (CPU), a graphic processing unit (GPU), various special purpose artificial intelligence (AI) computing chips, various computing units running a machine learning model algorithm, a digital signal processor (DSP), and any suitable processors, controllers, microcontrollers, etc. The computing unit 710 performs various methods and processes described above, such as a navigation route determination method. For example, in some embodiments, the navigation route determination method may be implemented as a computer software program tangibly included in a machine-readable medium, such as the storage unit 780. In some embodiments, part or all of the computer program may be loaded and/or installed on the electronic device 700 via the ROM 720 and/or the communication unit 790. When a computer program is loaded into the RAM 730 and executed by the computing unit 710, one or more steps of the navigation route determination method described above may be performed. Alternatively, in other embodiments, the computing unit 710 may be configured to perform the navigation route determination method by any other suitable means (e.g., via firmware).

Various implementations of the system and technology described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. These various implementations may include: implementing in one or more computer programs, which can be executed and/or interpreted on a programmable system including at least one programmable processor. The programmable processor may be a dedicated or general-purpose programmable processor, which can receive data and instructions from, and transmit the data and the instructions to, a memory system, at least one input device, and at least one output device.

Program code for implementing the method of the present disclosure may be edited in any combination of one or more programming languages. The program code may be provided to a processor or controller of a general purpose computer, special purpose computer, or other programmable data processing device such that the program code, when executed by the processor or controller, causes the functions/operations shown in the flow diagram and/or block diagram to be implemented. The program code may be executed entirely on a machine, partly on a machine, or as an independent software package partly on a machine and partly on a remote machine or entirely on a remote machine or server.

In the context of the present disclosure, a machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of a machine-readable storage medium may include an electrical connection based on one or more wires, a portable computer disk, a hard disk, a random access memory (RAM), a read-only memory (ROM), an erasable programmable read-only memory (EPROM or Flash Memory), an optical fiber, a portable compact disk read-only memory (CD-ROM), an optical storage device, a magnetic storage device, or any suitable combination thereof.

To provide the interaction with a user, the system and technology described herein may be applied on a computer having: a display device (e.g., a CRT (cathode ray tube) or LCD (liquid crystal display) monitor) for displaying information to the user; and a keyboard and a pointing device (e.g., a mouse or a trackball) through which the user can provide input to the computer. Other types of devices may also be used to provide the interaction with a user. For example, the feedback provided to the user may be any form of sensory feedback (e.g., visual feedback, auditory feedback, or tactile feedback); and input from the user may be received in any form (including acoustic input, voice input, or tactile input).

The system and technology described herein may be applied in a computing system that includes a background component (e.g., as a data server), or a computing system that includes a middleware component (e.g., an application server), or a computing system that includes a front-end component (e.g., a user computer having a graphical user interface or a web browser, wherein a user may interact with implementations of the system and technology described herein through the graphical user interface or the web browser), or a computing system that includes any combination of such background component, middleware component, or front-end component. The components of the system may be interconnected by digital data communication (e.g., a communication network) in any form or medium. Examples of the communication network include: Local Area Networks (LAN), Wide Area Network (WAN), and the Internet.

A computer system may include a client and a server. The client and server are generally remote from each other and typically interact through a communication network. The relationship of the client and the server is generated by computer programs running on the respective computers and having a client-server relationship with each other.

It should be understood that the steps in various forms described above may be reordered or omitted, or other steps may be added therein. For example, the steps described in the present disclosure may be performed in parallel or sequentially or may be performed in a different order, so long as the desired result of the technical solutions disclosed in the present disclosure can be achieved, and no limitation is made herein.

Above specific embodiments do not constitute a limitation on the protection scope of the present disclosure. It should be understood by those skilled in the art that various modifications, combinations, sub-combinations, and substitutions may be available according to design requirements and other factors. Any modifications, equivalent replacements and improvements made within the spirit and principle of the present disclosure shall be covered within the protection scope of the present disclosure.

What is claimed is:

1. A method for determining a navigation route, comprising:
acquiring a first candidate route within a first distance to a navigation destination from a map;
determining an attribute of the first candidate route, the attribute comprising a navigation route and a non-navigation route;
determining a target route with the attribute of the navigation route in the map based on at least one selected from a group consisting of the navigation destination and the first candidate route, in a case where the attribute of the first candidate route is the non-navigation route.

2. The method according to claim 1, wherein determining the target route with the attribute of the navigation route in the map based on at least one selected from a group consisting of the navigation destination and the first candidate route, in a case where the attribute of the first candidate route is the non-navigation route, comprises:
acquiring a second candidate route within a second distance to the navigation destination from the map, the attribute of the second candidate route being the navigation route;
determining the second candidate route as the target route, in a case where the second candidate route is connected to the first candidate route.

3. The method according to claim 2, wherein determining the second candidate route as the target route, in a case where the second candidate route is connected to the first candidate route, comprises:
setting a priority of each second candidate route based on a distance between each second candidate route and the navigation destination;
determining a connectivity between each second candidate route and the first candidate route based on the priority in sequence;
determining a second candidate route that is first determined to be connected to the first candidate route as the target route.

4. The method according to claim 2, wherein determining the target route with the attribute of the navigation route in the map based on at least one selected from a group consisting of the navigation destination and the first candidate route, in a case where the attribute of the first candidate route is the non-navigation route, further comprises:
calculating a distance between each second candidate route and the navigation destination, in a case where the second candidate route is not connected to the first candidate route;
determining the target route from the second candidate route based on the distance.

5. The method according to claim 1, wherein the second distance is dynamically adjusted based on the number of the first candidate route.

6. The method according to claim 2, wherein the second distance is dynamically adjusted based on the number of the first candidate route.

7. The method according to claim 3, wherein the second distance is dynamically adjusted based on the number of the first candidate route.

8. The method according to claim 4, wherein the second distance is dynamically adjusted based on the number of the first candidate route.

9. An electronic device, comprising:
at least one processor; and
a memory communicatively connected to the at least one processor; wherein,
the memory stores instructions executable by the at least one processor, and the instructions are executed by the at least one processor to enable the at least one processor to:
acquire a first candidate route within a first distance to a navigation destination from a map;
determine an attribute of the first candidate route, the attribute comprising a navigation route and a non-navigation route;
determine a target route with the attribute of the navigation route in the map based on at least one selected from a group consisting of the navigation destination and the first candidate route, in a case where the attribute of the first candidate route is the non-navigation route.

10. The electronic device according to claim 9, wherein the instructions are executed by the at least one processor to enable the at least one processor to:
acquire a second candidate route within a second distance to the navigation destination from the map, the attribute of the second candidate route being the navigation route;
determine the second candidate route as the target route, in a case where the second candidate route is connected to the first candidate route.

11. The electronic device according to claim 10, wherein the instructions are executed by the at least one processor to enable the at least one processor to:
set a priority of each second candidate route based on a distance between each second candidate route and the navigation destination;
determine a connectivity between each second candidate route and the first candidate route based on the priority in sequence;
determine a second candidate route that is first determined to be connected to the first candidate route as the target route.

12. The electronic device according to claim 10, wherein the instructions are executed by the at least one processor to enable the at least one processor to:
calculate a distance between each second candidate route and the navigation destination, in a case where the second candidate route is not connected to the first candidate route;
determine the target route from the second candidate route based on the distance.

13. The electronic device according to claim 9, wherein the second distance is dynamically adjusted based on the number of the first candidate route.

14. The electronic device according to claim 10, wherein the second distance is dynamically adjusted based on the number of the first candidate route.

15. The electronic device according to claim 11, wherein the second distance is dynamically adjusted based on the number of the first candidate route.

16. The electronic device according to claim 12, wherein the second distance is dynamically adjusted based on the number of the first candidate route.

17. A non-transitory computer-readable storage medium storing computer instructions, wherein the computer instructions are executed by a computer to enable the computer to:
acquire a first candidate route within a first distance to a navigation destination from a map;
determine an attribute of the first candidate route, the attribute comprising a navigation route and a non-navigation route;
determine a target route with the attribute of the navigation route in the map based on at least one selected from a group consisting of the navigation destination and the first candidate route, in a case where the attribute of the first candidate route is the non-navigation route.

18. The non-transitory computer-readable storage medium according to claim 17, wherein the computer instructions are executed by the computer to enable the computer to:
acquire a second candidate route within a second distance to the navigation destination from the map, the attribute of the second candidate route being the navigation route;
determine the second candidate route as the target route, in a case where the second candidate route is connected to the first candidate route.

19. The non-transitory computer-readable storage medium according to claim 18, wherein the computer instructions are executed by the computer to enable the computer to:
set a priority of each second candidate route based on a distance between each second candidate route and the navigation destination;
determine a connectivity between each second candidate route and the first candidate route based on the priority in sequence;
determine a second candidate route that is first determined to be connected to the first candidate route as the target route.

20. The non-transitory computer-readable storage medium according to claim 18, wherein the computer instructions are executed by the computer to enable the computer to:
calculate a distance between each second candidate route and the navigation destination, in a case where the second candidate route is not connected to the first candidate route;
determine the target route from the second candidate route based on the distance.
